(19) United States
(12) Patent Application Publication
(10) Pub. No.: US 2023/0376758 A1
(43) Pub. Date: Nov. 23, 2023

(54) MULTI-MODALITY ROOT CAUSE LOCALIZATION ENGINE

(71) Applicant: NEC Laboratories America, Inc., Princeton, NJ (US)

(72) Inventors: Zhengzhang Chen, Princeton Junction, NJ (US); Yuncong Chen, Plainsboro, NJ (US); LuAn Tang, Cranbury, NJ (US); Haifeng Chen, West Windsor, NJ (US)

(21) Appl. No.: 18/302,939

(22) Filed: Apr. 19, 2023

Related U.S. Application Data
(60) Provisional application No. 63/344,085, filed on May 20, 2022.
(60) Provisional application No. 63/344,091, filed on May 20, 2022.
(60) Provisional application No. 63/450,988, filed on Mar. 9, 2023.

(51) Int. Cl. G06N 3/08; G06N 3/0442; G06N 7/01

(52) U.S. Cl. CPC G06N 3/08; G06N 3/0442; G06N 7/01

(57) ABSTRACT

A method for employing root cause analysis is presented. The method includes embedding, by an embedding layer, a sequence of events into a low-dimension space, employing a feature extractor and representation learner to convert log data from the sequence of events to time series data, the feature extractor including an auto-encoder model and a language model, and detecting root causes of failure or fault activities from the time series data.

### RELATED APPLICATION INFORMATION

This application claims priority to Provisional Application No. 63/344,085 filed on May 20, 2022, Provisional Application No. 63/344,091 filed on May 20, 2022, and Provisional Application No. 63/450,988 filed on Mar. 9, 2023, the contents of all of which are incorporated herein by reference in their entirety.

### BACKGROUND

### Technical Field

The present invention relates to root cause localization and, more particularly, to a multi-modality root cause localization engine.

### Description of the Related Art

Root Cause Analysis (RCA) aims to identify the underlying causes of system faults (e.g., anomalies, malfunctions, errors, failures, etc.) based on system monitoring data. RCA has been used in Information technology (IT) operations, industrial process control, telecommunications, etc., because a failure or malfunction in these systems would affect user experiences and result in financial losses. To maintain the reliability and robustness of such systems, Key Performance Indicators (KPIs), such as latency or connection time in a microservice system, and metrics data, such as CPU/memory usages in a microservice system are often monitored and recorded in real-time for system diagnosis. The intricacy of these systems and the magnitude of the monitoring data, however, make manual root cause analysis unacceptably expensive and error prone.

### SUMMARY

A method for employing root cause analysis is presented. The method includes embedding, by an embedding layer, a sequence of events into a low-dimension space, employing a feature extractor and representation learner to convert log data from the sequence of events to time series data, the feature extractor including an auto-encoder model and a language model, and detecting root causes of failure or fault activities from the time series data.

A non-transitory computer-readable storage medium comprising a computer-readable program for employing root cause analysis is presented. The computer-readable program when executed on a computer causes the computer to perform the steps of embedding, by an embedding layer, a sequence of events into a low-dimension space, employing a feature extractor and representation learner to convert log data from the sequence of events to time series data, the feature extractor including an auto-encoder model and a language model, and detecting root causes of failure or fault activities from the time series data.

A system for employing root cause analysis is presented. The system includes a processor and a memory that stores a computer program, which, when executed by the processor, causes the processor to embed, by an embedding layer, a sequence of events into a low-dimension space, employ a feature extractor and representation learner to convert log data from the sequence of events to time series data, the feature extractor including an auto-encoder model and a language model, and detect root causes of failure or fault activities from the time series data.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of existing multi-modal root cause localization;

FIG. 2 is a block/flow diagram of an exemplary multi-modal root cause localization, in accordance with embodiments of the present invention;

FIG. 3 is a block/flow diagram of an exemplary overview of a multi-modality root cause localization system, in accordance with embodiments of the present invention;

FIG. 4 is an exemplary block/flow diagram of log messages and a log key sequence, in accordance with embodiments of the present invention;

FIG. 5 is a block/flow diagram of an exemplary overview of the multi-modality root cause localization system, in accordance with embodiments of the present invention;

FIG. 6 is a block/flow diagram of an exemplary processing system for employing root cause analysis, in accordance with embodiments of the present invention;

FIG. 7 is a block/flow diagram of an exemplary method for employing root cause analysis, in accordance with embodiments of the present invention;

FIG. 8 illustrates equations enabling a long short-term memory (LSTM) encoder to learn representations of a whole sequence and equations enabling an LSTM decoder to reconstruct the original sequence recursively, in accordance with embodiments of the present invention; and

FIG. 9 illustrates equations pertaining to the objective function and equations predicting the next event in the language model, in accordance with embodiments of the present invention.

### DETAILED DESCRIPTION OF PREFERRED EMBODIMENTS

The challenges mainly come from the complex system and data, such as the hierarchical and evolving topology structures. Large-scale information systems usually include different levels of components that work together in a highly complex, coordinated, and evolving manner. One example is cloud computing facilities with microservice architectures, which usually include hundreds of different levels of components that vary from operating systems, application software, etc.

The challenges further come from the generation of terabytes of heterogeneous data per day including metrics data, log data, and event data that overwhelm Ops engineers. Each type/source of data offers some clues, but due to complexity and volume, each is difficult to manually analyze, let alone collectively analyze all data sources.

The exemplary embodiments address the issue of multi-modality root cause localization. More specifically, by collecting the monitored system performance data (such as latency, connection time, idle time, etc.) and a set of multi-modality data including metrics and logs of all the running containers/nodes and pods before and after the failure/fault events happen, the goal is to accurately and effectively detect the top-k pods and/or nodes that are most likely to be the candidates of the root cause of the failure/fault activities. This technology can be used to aid in failure/fault diagnosis in cloud/microservice systems, which is a core problem of AIOps (Artificial Intelligence for IT Operations).

The exemplary embodiments introduce a multi-modality root cause localization engine. Most existing root cause analysis techniques process time series and event logs separately, and thus cannot capture interplay between different data sources. Also, their time series monitoring cannot adjust the detection strategy based on system context revealed by events. Moreover, their event log analysis lacks the ability to identify the causes and implications in terms of system metrics and key performance indicators (KPIs).

The innovation of the exemplary embodiments relates to a monitoring agent designed to collect multi-modality data including performance KPI, metrics, and log data from the whole system and the underlying system components. A feature extraction or representation learning component is presented to convert the log data to time series data, so that the root cause analysis technique for time series, especially the causal discovery or inference methods, can be applied. To prioritize the metrics for root cause analysis and learn the importance of different metrics, the exemplary methods design a metric prioritization component based on the extreme value theory. To the integrated analysis of the multi-modality data, the exemplary methods employ a hierarchical graph neural network-based method to rank the root causes and learn the knowledge graph for further system diagnosis. The exemplary methods further utilize heterogeneous information to learn important inter-silo dynamics that existing methods cannot process.

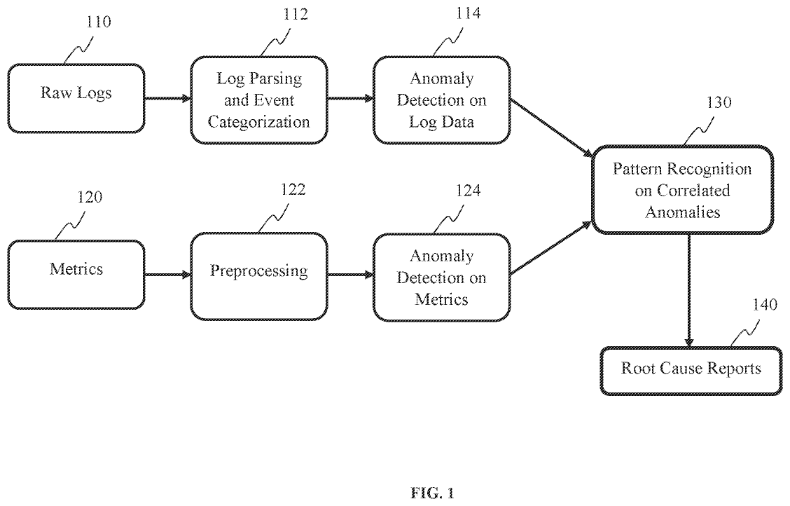

FIG. 1 is a block/flow diagram of existing multi-modal root cause localization.

The raw logs 110 are fed into the log parsing and event categorization component 112. Anomaly detection is performed on the log data via the anomaly detection component 114. The metrics 120 are pre-processed by the preprocessing component 122 and fed into the anomaly detection component 124 configured to detect anomalies on the metrics 120. The detected anomalies are fed into the pattern recognition component 130 and root cause reports 140 are generated.

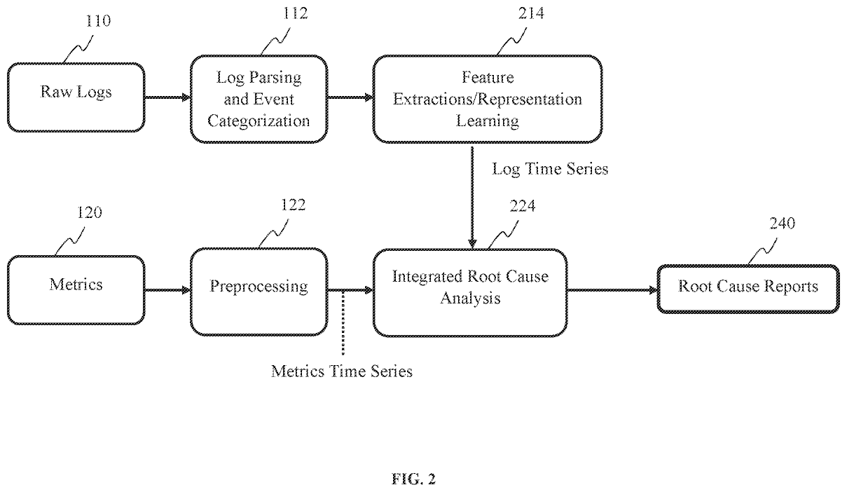

FIG. 2 is a block/flow diagram of an exemplary multi-modal root cause localization, in accordance with embodiments of the present invention.

The raw logs 110 are fed into the log parsing and event categorization component 112. The data is then provided to the feature extraction/representation learning component 214. The metrics 120 are pre-processed by the preprocessing component 122 and fed into the root cause analysis component 224 with the log time series data received from the feature extraction/representation learning component 214. Root cause reports 240 are then generated.

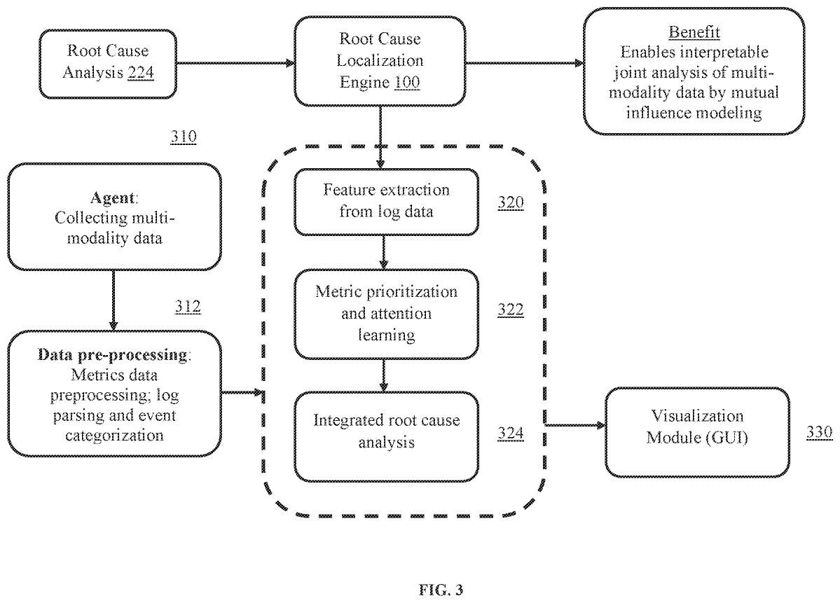

FIG. 3 is a block/flow diagram of an exemplary overview of a multi-modality root cause localization system, in accordance with embodiments of the present invention.

Regarding multi-modality data collection, the agent 310 collects the multimodality data by employing the open-source software like JMeter, Jaeger, and/or Openshift/Prometheus. Three types of monitored data are used in the root cause analysis engine, that is, the Key Performance Indicator (KPI) data of the whole system, the metrics data of the running containers/nodes and the applications/pods, and the log data of the containers and running pods.

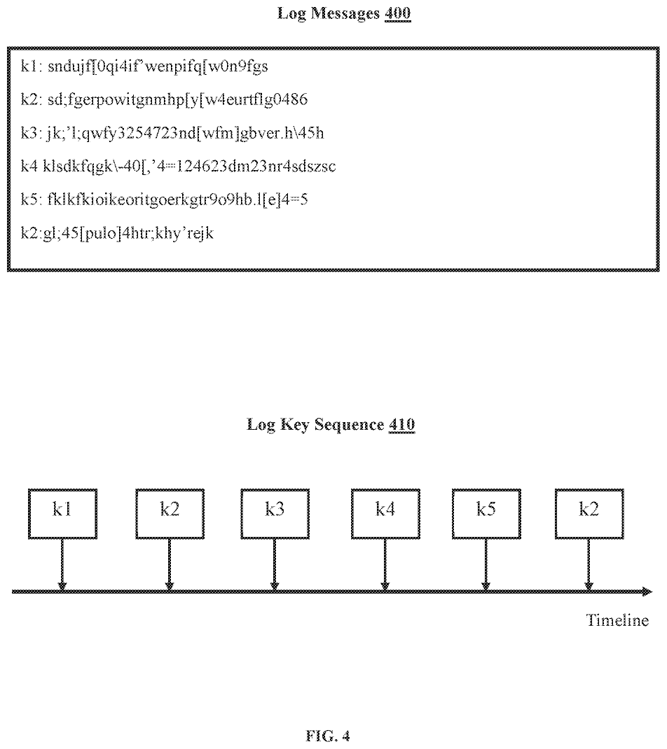

Regarding the data preprocessing component 312, for the log data, the exemplary methods first utilize an open-sourced log parser like “Drain” to learn the structure of the logs and parse them into event/value or key/value pairs as shown in FIG. 4, where the log messages 400 are parsed into the log key sequences 410. Based on the key/value pairs, the exemplary methods then categorize log messages into a “dictionary” of unique event types according to the involved system entities. For example, if two log messages include the entry of a same pod, they belong to the same category. And for each category, log keys are sliced using time sliding windows.

For metrics data, it is possible that there are different levels of data like high-level (e.g., node level) system metric data and low-level (e.g., pod-level) system metric data and for each level, there are different metrics (like CPU usage, memory usage, etc.). The data of the same level is extracted, and the same metric is used to construct the multivariate time series with columns representing system entities (like pods) and rows representing different timestamps.

Regarding the feature extraction/representation learning on log data 320 (feature extractor 320), to capture the interplay between metrics and log data, the exemplary methods employ feature extraction or representation learning techniques to convert log data into the same format (e.g., time series) as metrics data. A novel representation learning model with two sub-components for log data is presented. The first is an auto-encoder model and the second is a language model.

Before delving into the representation learning model, learning embeddings for events is presented. The inputs of the framework are the sequences of events, where each event eₜ is represented by a one-hot vector and e[i=j]=1, e[i≠j]=0 if eₜ is the j^{th} event in the event set, i.e., E. In real-world scenarios, event space could be very large, e.g., there can be thousands of event types. This can lead eₜ to be high-dimensional, causing learning issues such as, e.g., sparsity. Thus, the exemplary methods design an embedding layer to embed events into a low-dimension space. To do so, the exemplary methods introduce an embedding matrix E∈R^{d}^{^{e}}^{×|E|}, where d^{e} is the dimension of the embedding space and |E| is the number of event types in E. With this, the representation of eₜ can be obtained as follows:

xₜ=E^{T}·eₜ

where xₜ∈R^{d}^{^{e}} is the new low-dimensional dense representation vector for eₜ. After embedding layer, the input sequences will be passed into the other framework components, which will introduced next.

The auto-encoder includes an encoder network and a decoder network. The encoder network encodes a categorical sequence into a low-dimensional dense real-valued vector, from which the decoder aims to reconstruct the sequence. Due to its effectiveness for sequence modeling, long short-term memory (LSTM) is used as the base model for both the encoder and the decoder networks.

Specifically, given a normal sequence in the training set, e.g., Sⁱ=(x₁ⁱ, x₂ⁱ, . . . x_{N}_{ⁱ}ⁱ), the LSTM encoder is used to learn a representation of the whole sequence, step by step, as follows:

fₜ=σ_{g}(W_{f}xₜⁱ+U_{f}hₜ₋₁+b_{f})

iₜ=σ_{g}(Wᵢxₜⁱ+Uᵢhₜ₋₁+bᵢ)

oₜ=σ_{g}(Wₒxₜⁱ+Uₒhₜ₋₁+bₒ)

\tilde{c}ₜ=tanh(W_{c}xₜ+U_{c}hₜ₋₁+b_{c})

cₜ=fₜ⊙cₜ₋₁+iₜ+\tilde{c}ₜ

hₜ=oₜ⊙cₜ (1)

Here xₜ is the input embedding of the t^{th} element in Sⁱ, fₜ, iₜ, oₜ are named as forget gate, input gate, output gate, respectively. In addition, W_{*}, U_{*}, and b_{*}(*∈{f,i,o,c}) are all trainable parameters of the LSTM. The exemplary methods use the final state h_{N}_{ⁱ} obtained by LSTM as the representation of the whole sequence as it summarizes all the information in the previous steps. With the sequence representation h_{N}_{ⁱ}, the LSTM decoder attempts to reconstruct the original sequence recursively as follows:

hₜⁱ=LSTM(hₜ₋₁,\tilde{x}ₜ₋₁ⁱ)

pₜⁱ=Softmax(ReLU(W^{p}hₜⁱ+b^{p}))

êₜⁱ=OneHot(argmax(pₜⁱ)

\hat{x}ₜⁱ=E^{T}·êₜⁱ (2)

Here LSTM is defined in Equation (1), and pₜⁱ∈ [symbol] ^{|E|} is the probability distribution over all possible events. Wₚ and b^{p} are trainable parameters. argmax is the function to obtain the index of largest entry of pₜⁱ, Softmax is to normalize the probability distribution and ReLU is an activation function defined as:

ReLU(x)=max(0,x) (3)

Moreover, êₜⁱ is the predicted event at step t. In addition, the start hidden state and input event are h_{N}_{ⁱ} and special SOS event, respectively.

To optimize the parameters for the encoder and decoder, the negative log likelihood loss is used as the objective function, which is defined as follows:

$${L}_{A E} = {\sum }_{i = 1}^{N} {\sum }_{j = 1}^{{N}^{i}} - l o g ( {e}_{j}^{iT} {p}_{j}^{i} ) \qquad ( 4 )$$

When the encoder and decoder are trained to reach their optimum, that it, difference between the original and reconstructed sequences is minimum, the representation vector, e.g., h_{N}_{ⁱ} produced by the encoder includes as much information of the sequence as possible.

Regarding the language model, the language model is trained to predict the next event given the previous events in the sequences. Again, an LSTM model is used as the base of the language model. Correctly, given the previous events of at step t, the next event is predicted as:

hₜⁱ=LSTM((x₁ⁱ,x₂ⁱ, . . . ,xₜⁱ))

pₜ₊₁ⁱ=Softmax(ReLU(W^{l}hₜⁱ+b^{l}))

êₜ₊₁ⁱ=OneHot(argmax(pₜ₊₁ⁱ)) (5)

Again, pₜ₊₁ⁱ, is the probability distribution over all possible events and êₜ₊₁ⁱ is the one-hot representation of the predicted next event. Similarly, the negative log likelihood loss is used as the objective function. In this way, the trained language model is able to incorporate sequential dependencies in the sequences and measure the likelihood of any given sequence. This likelihood measurement and the vector produced by the encoder are concatenated together to form the final representation of a sequence, that is, v.

The feature extraction component 320 is quite flexible. Different feature extraction or representation learning techniques can be applied. An alternative way is to employ the Principle Component Analysis (PCA) based method. Specifically, the exemplary methods first construct a count matrix M, where each row represents a sequence, each column denotes a log key, and each entry M(i,j) indicates the count of jth log key in the ith sequence. Next, PCA learns a transformed coordinate system with the projection lengths of each sequence. The projection lengths form the time series of log data.

One example of the converted time series by extracting features from log data can be found below:

| Time | Pod | Extracted Feature Value |
|---|---|---|
| 2021 Dec. 2 23:00:07+00:00 | book-info_ratings-v2-5bddd98984-wwnhx | 0.1 |
| 2021 Dec. 2 23:00:19+00:00 | book-info_ratings-v2-5bddd98984-wwnhx | 0.3 |
| 2021 Dec. 2 23:00:31+00:00 | book-info_ratings-v2-5bddd98984-wwnhx | 0.5 |
| 2021 Dec. 2 23:00:43+00:00 | book-info_ratings-v2-5bddd98984-wwnhx | 0.8 |

Regarding the metrics prioritization and attention learning component 322 (metric prioritizer and attention learner 322), after the feature extractor 320, the log data have been successfully converted into time series data, which is in the same format of metrics data. Now each extracted feature or representation of log can be considered as another metric in addition to CPU usage, memory usage, etc. Different metrics contribute to the failure event differently. For example, the CPU usage contributes more than the other metrics on the failure cases related to the high CPU load.

To prioritize the metrics for root cause analysis and learn the importance of different metrics, the exemplary methods adopt the extreme value theory-based method named SPOT. It is assumed that the root cause metrics should become anomalous in some time before failure time. The anomaly degree of metrics is evaluated based on SPOT.

The exemplary methods define the anomaly degree of the metric i as di. Given a time series of metric Mⁱ=M₀ⁱ, M₁ⁱ, . . . , M_{T}ⁱ the index set of the anomaly point of Mⁱ is ε. The threshold in SPOT is denoted as Mₜⁱ is ω_{M}_{ₜ}_{ⁱ}. Then the ∂ⁱ is calculated as follows:

$${\partial }^{i} = {max}_{j ∈ ε} \frac{\vert {M}_{j}^{i} - {ω}_{{M}_{j}^{i}} \vert}{{ω}_{{M}_{j}^{i}}}$$

Since it is often that there are many time series of metric Mⁱ (e.g., 100 different pods with the CPU usage metric), the maximum one ∂ₘₐₓⁱ is chosen as the representative.

The metric with a larger ∂ₘₐₓⁱ has a higher priority. If there are too many metrics, to reduce the computational cost in the root cause analysis, the metrics with very low priorities can be discarded. The normalized ∂ₘₐₓⁱ will be used as the attention/weight for the metric in the integrated root cause analysis 324.

Regarding the integrated root cause analysis 324 (integrated root cause analyzer 324), for each metric data including the log as one metric, the exemplary methods apply the hierarchical graph neural network-based method to localize the root causes. When a system failure happens, it first conducts topological cause learning by extracting causal relations and propagating the system failure over the learned causal graph. Consequently, a topological cause score representing how much a component can be the root cause will be obtained. Second, it applies an individual cause learning via the extreme value theory to detect anomalous entities. By aggregating the results from topological cause learning and individual cause learning, a root cause ranking is obtained to discover most probable root causes, as well as a causal graph serving as a system knowledge graph for system insights.

After applying root cause localization for all the metrics, the exemplary methods assign the learned attention/weight to each metric and aggregate the results to generate the final root cause ranking, which is displayed by the visualization display 330.

Therefore, in conclusion, the proposed method is the first engine for interpretable joint root cause analysis of time series and events by mutual influence modeling. By ingesting heterogeneous data from different sources across all components of the IT environment, the exemplary methods break data silos and enhance monitoring and diagnose efficiency by understanding the interplay between system components.

In contrast to existing approaches, the exemplary embodiments combine latent states from both time series and log event streams to discover influence patterns between different log events and metrics and to capture uncertainty. The exemplary methods are more accurate (e.g., provide for higher quality) on root cause localization. Hence, the generated root causes will have less false positives and false negatives.

In contrast to traditional anomaly detection-based root cause analysis approaches for log data, the exemplary framework enables a user to extend the causal discovery/interference methods on time series to log data.

Traditional methods can only leverage the metrics directly collected by the monitoring agents, whereas the exemplary feature extraction/representation learning method enables a user to learn different features or representations from log data as additional metrics for root cause analysis.

In traditional root cause identification methods of microservice systems, prior knowledge is needed to select the correlated metrics to the root cause. In contrast, the exemplary methods automatically prioritize the metrics for root cause analysis to reduce the computational cost and learn the importance of each metric. Moreover, the proposed method can be applied in real-time root cause identification.

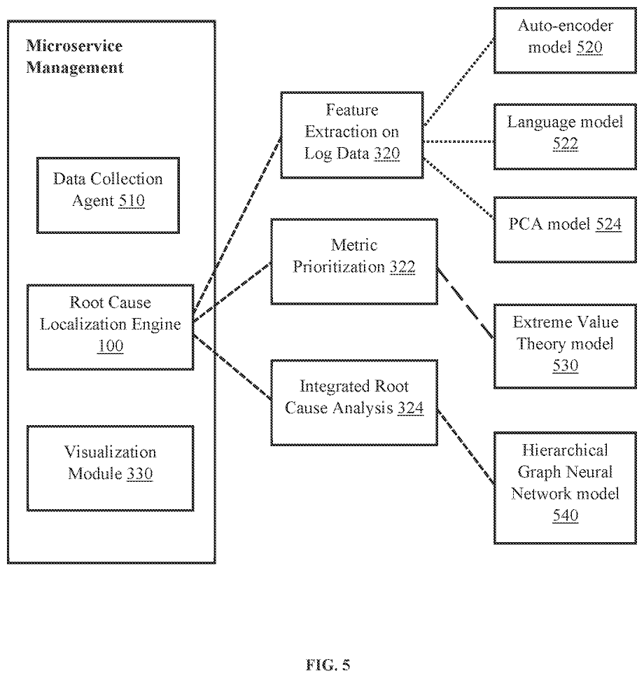

FIG. 5 is a block/flow diagram of an exemplary overview of the multi-modality root cause localization system, in accordance with embodiments of the present invention.

The microservice management system includes a data collection agent 510, the root cause localization engine 100, and the visualization display 330. The root cause localization engine 100 employs the feature extraction component 320, metric prioritization component 322, and the integrated root cause analysis component 324.

The feature extraction component 320 employs an autoencoder model 520, a language model 522, and a PCA model 524. The metric prioritization component 322 employs the extreme value theory model 530. The integrated root cause analysis component 324 employs the hierarchical graph neutral network model 540.

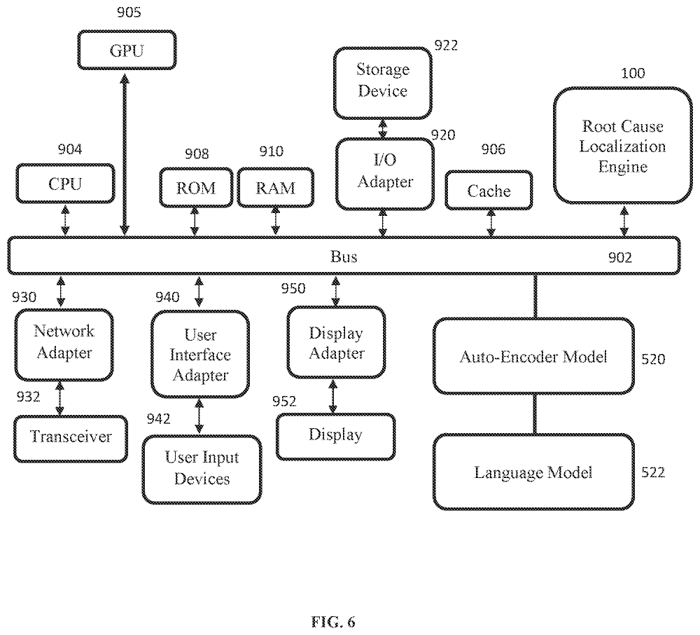

FIG. 6 is an exemplary processing system for employing root cause analysis, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the root cause localization engine 100 employs an auto-encoder model 520 and a language model 522.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

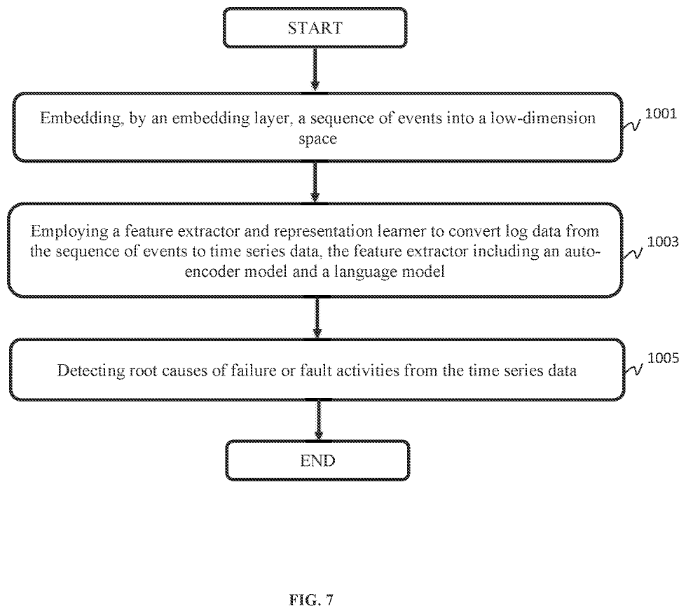

FIG. 7 is a block/flow diagram of an exemplary method for employing root cause analysis, in accordance with embodiments of the present invention.

At block 1001, embed, by an embedding layer, a sequence of events into a low-dimension space.

At block 1003, employ a feature extractor and representation learner to convert log data from the sequence of events to time series data, the feature extractor including an auto-encoder model and a language model.

At block 1005, detect root causes of failure or fault activities from the time series data.

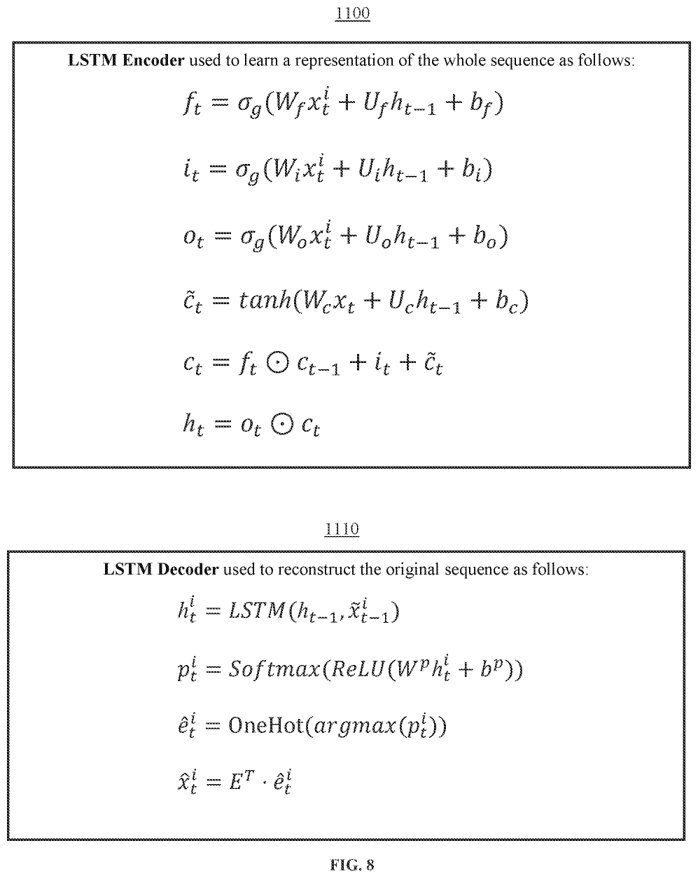

FIG. 8 illustrates equations 1100 enabling a long short-term memory (LSTM) encoder to learn representations of a whole sequence and equations 1110 enabling an LSTM decoder to reconstruct the original sequence recursively, in accordance with embodiments of the present invention.

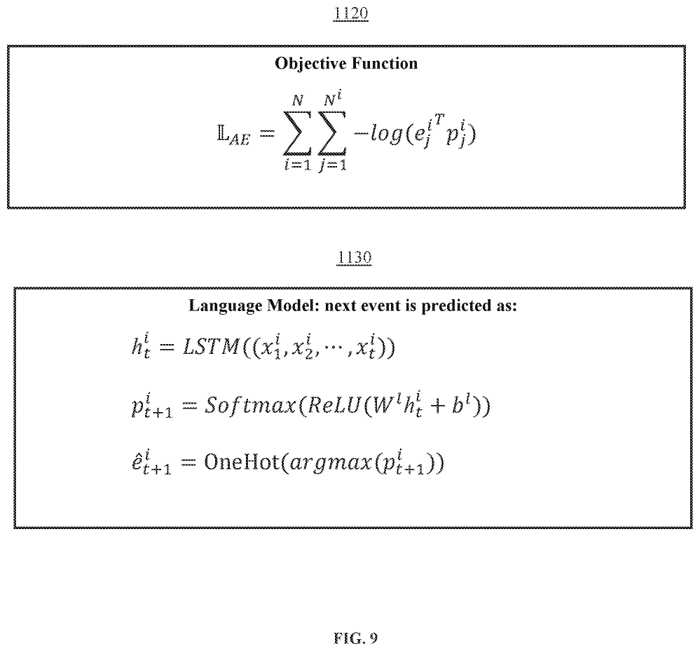

FIG. 9 illustrates equations pertaining to the objective function 1120 and equations 1130 predicting the next event in the language model, in accordance with embodiments of the present invention.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for employing root cause analysis, the method comprising:
embedding, by an embedding layer, a sequence of events into a low-dimension space;
employing a feature extractor and representation learner to convert log data from the sequence of events to time series data, the feature extractor including an auto-encoder model and a language model; and
detecting root causes of failure or fault activities from the time series data.

2. The method of claim 1, wherein the auto-encoder model includes a long short-term memory (LSTM) encoder network and an LSTM decoder network.

3. The method of claim 2, wherein the LSTM encoder network learns a representation of a whole sequence as follows:
fₜ=σ_{g}(W_{f}xₜⁱ+U_{f}hₜ₋₁+b_{f})
iₜ=σ_{g}(Wᵢxₜⁱ+Uᵢhₜ₋₁+bᵢ)
oₜ=o_{g}(Wₒxₜⁱ+Uₒhₜ₋₁+bₒ)
cₜ=tanh(W_{c}xₜ+U_{c}hₜ₋₁+b_{c})
cₜ=fₜ⊙cₜ₋₁+iₜ+cₜ
hₜ=oₜ⊙cₜ,
where xₜ is an input embedding of the t^{th} element in a training set Sⁱ, fₜ, iₜ, oₜ are a forget gate, an input gate, and an output gate, respectively, W_{*}, U_{*}, and b_{*}(*∈{f, i, o, c}) are all trainable parameters of the LSTM, and h_{N}_{ⁱ} is a final hidden state obtained by the LSTM.

4. The method of claim 2, wherein the LSTM decoder network reconstructs the whole sequence as follows:
hₜⁱ=LSTM(hₜ₋₁,xₜ₋₁ⁱ)
pₜⁱ=Softmax(ReLU(W^{p}hₜⁱ+b^{p}))
eₜⁱ=OneHot(argmax(pₜⁱ)
xₜⁱ=E^{T}·eₜⁱ,
where pₜⁱ∈R^{|E|} is a probability distribution over all possible events, W^{p} and b^{p} are trainable parameters, argmax is a function to obtain an index of largest entry of pₜⁱ, Softmax normalizes the probability distribution, ReLU is an activation function defined as ReLU(x)=max(0,x),eₜⁱ is a predicted event at step t, and h_{N}_{ⁱ} represents hidden states.

5. The method of claim 2, wherein parameters of the LSTM encoder network and the LSTM decoder network are optimized by an objective function defined as:
$${L}_{A E} = {\sum }_{i = 1}^{N} {\sum }_{j = 1}^{{N}^{i}} - log ( {e}_{j}^{iT} {p}_{j}^{i} ) ,$$
where eⱼⁱ^{^{T}} is a predicted event and pⱼⁱ is a probability distribution over all possible events.

6. The method of claim 1, wherein the language model is trained to predict a next event given previous events in a categorical sequence.

7. The method of claim 6, wherein the next event is predicted as:
hₜⁱ=LSTM((x₁ⁱ,x₂ⁱ, . . . ,xₜⁱ))
pₜ₊₁ⁱ=Softmax(ReLU(W^{l}hₜⁱ+b^{l}))
eₜ₊₁ⁱ=OneHot(argmax(pₜ₊₁ⁱ)),
where pₜ₊₁ⁱ a probability distribution over all possible event, eₜ₊₁ⁱ is a one-hot representation the predicted next event, Softmax normalizes the probability distribution, ReLU is an activation function defined as ReLU(x)=max(0,x), argmax is a function to obtain an index of largest entry of pₜⁱ, W^{l} and b^{l} are trainable parameters, and hₜⁱ represent hidden states.

8. A non-transitory computer-readable storage medium comprising a computer-readable program for employing root cause analysis, wherein the computer-readable program when executed on a computer causes the computer to perform the steps of:
embedding, by an embedding layer, a sequence of events into a low-dimension space;
employing a feature extractor and representation learner to convert log data from the sequence of events to time series data, the feature extractor including an auto-encoder model and a language model; and
detecting root causes of failure or fault activities from the time series data.

9. The non-transitory computer-readable storage medium of claim 8, wherein the auto-encoder model includes a long short-term memory (LSTM) encoder network and an LSTM decoder network.

10. The non-transitory computer-readable storage medium of claim 9, wherein the LSTM encoder network learns a representation of a whole sequence as follows:
fₜ=σ_{g}(W_{f}xₜⁱ+U_{f}hₜ₋₁+b_{f})
iₜ=σ_{g}(Wᵢxₜⁱ+Uᵢhₜ₋₁+bᵢ)
oₜ=σ_{g}(Wₒxₜⁱ+Uₒhₜ₋₁+bₒ)
cₜ=tanh(W_{c}xₜ+U_{c}hₜ₋₁+b_{c})
cₜ=fₜ⊙cₜ₋₁+iₜ+cₜ
hₜ=oₜ⊙cₜ,
where xₜ is an input embedding of the t^{th} element in a training set Sⁱ, fₜ, iₜ, oₜ are a forget gate, an input gate, and an output gate, respectively, W_{*}, U_{*}, and b_{*} (*∈{f,i,o,c}) are all trainable parameters of the LSTM, and h_{N}_{ⁱ} is a final hidden state obtained by the LSTM.

11. The non-transitory computer-readable storage medium of claim 9, wherein the LSTM decoder network reconstructs the whole sequence as follows:
hₜⁱ=LSTM(hₜ₋₁,xₜ₋₁ⁱ)
pₜⁱ=Softmax(ReLU(W^{p}hₜⁱ+b^{p}))
eₜⁱ=OneHot(argmax(pₜⁱ)
xₜⁱ=E^{T}·eₜⁱ,
where pₜⁱ∈R^{|E|} is a probability distribution over all possible events, W^{p} and b^{p} are trainable parameters, argmax is a function to obtain an index of largest entry of pₜⁱ, Softmax normalizes the probability distribution, ReLU is an activation function defined as ReLU(x)=max(0,x),eₜⁱ is a predicted event at step t, and h_{N}_{ⁱ} represents hidden states.

12. The non-transitory computer-readable storage medium of claim 9, wherein parameters of the LSTM encoder network and the LSTM decoder network are optimized by an objective function defined as:
$${L}_{A E} = {\sum }_{i = 1}^{N} {\sum }_{j = 1}^{{N}^{i}} - log ( {e}_{j}^{iT} {p}_{j}^{i} ) ,$$
where eⱼⁱ^{^{T}} is a predicted event and pⱼⁱ is a probability distribution over all possible events.

13. The non-transitory computer-readable storage medium of claim 8, wherein the language model is trained to predict a next event given previous events in a categorical sequence.

14. The non-transitory computer-readable storage medium of claim 13, wherein the next event is predicted as:
hₜⁱ=LSTM((x₁ⁱ,x₂ⁱ, . . . ,xₜⁱ))
pₜ₊₁ⁱ=Softmax(ReLU(W^{l}hₜⁱ+b^{l}))
eₜ₊₁ⁱ=OneHot(argmax(pₜ₊₁ⁱ))
where pₜ₊₁ⁱ a probability distribution over all possible event, eₜ₊₁ⁱ is a one-hot representation the predicted next event, Softmax normalizes the probability distribution, ReLU is an activation function defined as ReLU(x)=max(0,x), argmax is a function to obtain an index of largest entry of pₜⁱ, W^{l} and b^{l} are trainable parameters, and hₜⁱ represent hidden states.

15. A system for employing root cause analysis, the system comprising:
a processor; and
a memory that stores a computer program, which, when executed by the processor, causes the processor to:
embed, by an embedding layer, a sequence of events into a low-dimension space;
employ a feature extractor and representation learner to convert log data from the sequence of events to time series data, the feature extractor including an auto-encoder model and a language model; and
detect root causes of failure or fault activities from the time series data.

16. The system of claim 15, wherein the auto-encoder model includes a long short-term memory (LSTM) encoder network and an LSTM decoder network.

17. The system of claim 16, wherein the LSTM encoder network learns a representation of a whole sequence as follows:
fₜ=σ_{g}(W_{f}xₜⁱ+U_{f}hₜ₋₁+b_{f})
iₜ=σ_{g}(Wᵢxₜⁱ+Uᵢhₜ₋₁+bᵢ)
oₜ=σ_{g}(Wₒxₜⁱ+Uₒhₜ₋₁+bₒ)
cₜ=tanh(W_{c}xₜ+U_{c}hₜ₋₁+b_{c})
cₜ=fₜ⊙cₜ₋₁+iₜ+cₜ
hₜ=oₜ⊙cₜ,
where xₜ is an input embedding of the t^{th} element in a training set Sⁱ, fₜ, iₜ, oₜ are a forget gate, an input gate, and an output gate, respectively, W_{*}, U_{*}, and b_{*} (*∈{f,i,o,c}) are all trainable parameters of the LSTM, and h_{N}_{ⁱ} is a final hidden state obtained by the LSTM.

18. The system of claim 16, wherein the LSTM decoder network reconstructs the whole sequence as follows:
hₜⁱ=LSTM(hₜ₋₁,xₜ₋₁ⁱ)
pₜⁱ=Softmax(ReLU(W^{p}hₜⁱ+b^{p}))
eₜⁱ=OneHot(argmax(pₜⁱ)
xₜⁱ=E^{T}·eₜⁱ,
where pₜⁱ∈R^{|E|} is a probability distribution over all possible events, W^{p} and b^{p} are trainable parameters, argmax is a function to obtain an index of largest entry of p Softmax normalizes the probability distribution, ReLU is an activation function defined as ReLU(x)=max(0,x),eₜⁱ is a predicted event at step t, and h_{N}_{ⁱ} represents hidden states.

19. The system of claim 16, wherein parameters of the LSTM encoder network and the LSTM decoder network are optimized by an objective function defined as:
$${L}_{A E} = {\sum }_{i = 1}^{N} {\sum }_{j = 1}^{{N}^{i}} - log ( {e}_{j}^{iT} {p}_{j}^{i} ) ,$$
where eⱼⁱ^{^{T}} is a predicted event and pⱼⁱ is a probability distribution over all possible events.

20. The system of claim 15, wherein the language model is trained to predict a next event given previous events in a categorical sequence and wherein the next event is predicted as:
hₜⁱ=LSTM((x₁ⁱ,x₂ⁱ, . . . ,xₜⁱ))
pₜ₊₁ⁱ=Softmax(ReLU(W^{l}hₜⁱ+b^{l}))
eₜ₊₁ⁱ=OneHot(argmax(pₜ₊₁ⁱ)),
where pₜ₊₁ⁱ a probability distribution over all possible event, eₜ₊₁ⁱ is a one-hot representation the predicted next event, Softmax normalizes the probability distribution, ReLU is an activation function defined as ReLU(x)=max(0,x), argmax is a function to obtain an index of largest entry of pₜⁱ, W^{l} and b^{l} are trainable parameters, and hₜⁱ represent hidden states.
